(19) United States
(12) Patent Application Publication
(10) Pub. No.: US 2022/0147967 A1
(43) Pub. Date: May 12, 2022

(54) SYSTEMS AND METHODS FOR COLLABORATIVE MONEY MANAGEMENT

(71) Applicant: Proactive Fintech LLC, Pleasant Grove, UT (US)

(72) Inventor: Ryan J. Clark, Cedar Hills, UT (US)

(21) Appl. No.: 17/524,678

(22) Filed: Nov. 11, 2021

Related U.S. Application Data
(60) Provisional application No. 63/112,507, filed on Nov. 11, 2020.

(51) Int. Cl. G06Q 20/22; G06Q 20/42; G06Q 20/10

(52) U.S. Cl. CPC G06Q 20/22; G06Q 20/10; G06Q 20/42

(57) ABSTRACT

Systems and methods for collaborative money management. In some embodiments, the system may allow for creation of a series of virtual and/or sub-accounts that may be shared with other users in the network according to a series of restrictions/rules that may be established by users of the system. Users may then decide, either unilaterally or after receiving a request from another user, to share a certain amount of money within an account with one or more other users, subject to rules that may be established, such as limits on the spending amount, allowed merchants, geographical restrictions, temporal restrictions, and the like. Once the transaction has been approved and takes place, any remaining funds may be automatically returned to the sharing user without requiring repayment or returning of remaining funds/change from the transaction.

### CROSS-REFERENCE TO RELATED APPLICATIONS

This application claims the benefit of U.S. Provisional Patent Application No. 63/112,507, filed Nov. 11, 2020, and titled “SYSTEMS AND METHODS FOR COLLABORATIVE MONEY MANAGEMENT,” which is hereby incorporated herein by reference in its entirety.

### SUMMARY

Systems and methods are disclosed herein that relate to sharing funds and/or collaboratively managing money. For example, the inventive concepts disclosed herein may be used to provide systems and/or methods to allow a group of users to share money with one another to improve budgeting, spending habits, and/or eliminate the hassles of borrowing money and/or spending money contributed by others.

In preferred embodiments, the inventive systems and/or methods may allow users to establish an account with a system operable on, for example, a mobile application and then create a series of virtual and/or sub-accounts that may be shared with other users in the network according to a series of restrictions/rules that may be established by users of the system. For example, a first user may decide to establish a virtual account in a spending category of “groceries.” That user may then decide, either unilaterally or after receiving a request from another user, to share a certain amount of money within this account with the other user, subject to rules including not only a limit to the spend amount, but potentially what merchants may be allowed, geographical restrictions, temporal restrictions, and the like. Once the transaction has been approved and takes place, any remaining funds may be automatically returned to the sharing user without requiring repayment or returning of change from the transaction.

In other embodiments, multiple users in the system may create joint virtual or other accounts with other users in the system that may allow multiple users to both contribute to and spend from a single account. For example, two users in a system, such as two employees of a business, may create a joint account within the system for a specific purpose, such as funding a vacation together or funding a project. Both users, or more than two users, may then contribute funds to the account, either at one time or repeatedly over a period of time, according to one or more rules or restrictions the users may jointly create. Both users may then spend from the joint account, again, subject to one or more rules/restrictions as created by the users.

In still other embodiments, users of the system may be allowed to split the costs of a single transaction, which may involve one or more items purchased together. Users may be allowed to propose a split before a transaction has taken place or after the transaction has taken place. For example, if a first user desires to split the costs of a proposed transaction between one or more other users, the first user may send a request to the other users that may include, for example, the proposed split amount/percentage, the total cost of the transaction, the vendor and/or items in the transaction, the identity and/or number of users involved in the split, personal notes, etc. The other users may then approve or decline the proposed split. If approved, funds may automatically be transferred between accounts at or immediately following the transaction without requiring the users to create a debtor scenario or otherwise take any further steps to pay the originating/requesting user.

If a user desires to split a transaction that has already taken place, the user may identify the transaction from a series of transactions made using the account/card of the user and then similarly propose a split of the costs amongst various other users. Again, if approved, funds may be automatically transferred to the requesting user according to the proposed split. Some embodiments may also be configured to apply any refunds associated with the split transaction to each of the users according to the original split amount/percentage.

In a more particular example of a method for collaborative money management between a plurality of users of a money management system according to some implementations, the method may comprise receiving a transaction split request from a first user of a collaborative money management system, such as receiving at a server a transaction split request from a mobile application or a web-based application under control of the first user. The method may further comprise sending a transaction split request notification to a second user of the collaborative money management system. In some implementations, the transaction split request may comprise a total cost of a transaction and a proposed split of the total cost of the transaction. A notification may be received from the second user responsive to the transaction split request. Following a determination that the second user has approved the transaction split request, in some implementations and embodiments, funds may be automatically transferred between accounts of the first user and the second user (including a third or more users in some cases) of the collaborative money management system to accomplish the approved transaction split request. In some cases, this transfer of funds may take place automatically at the time the transaction is posted and/or completed.

In some implementations, the system may further facilitate completion of the transaction. For example, the system may allow one user to use a virtual account, which may be linked with a financial institution account, to purchase an item or otherwise complete a transaction, after which the agreed-upon split may take place automatically by transferring funds between the involved users' virtual accounts in the system, which may allow the user initiating the transaction to complete the transaction without ever practically, or in some cases actually, requiring that this user provide all of the funds for the transaction.

In some implementations, the step of facilitating completion of the transaction may take place before the step of sending the transaction split request notification. Alternatively, of course, the transaction may be completed before the transaction split request, which may allow a user of the system to be reimbursed for transactions previously made.

In some implementations, the step of facilitating completion of the transaction may comprise receiving a transaction notification associated with a payment means, such as a debit card. In some such implementations, the payment means may be linked with a virtual account and/or the virtual account may be linked with a financial institution account.

In some implementations, the step of automatically transferring funds between accounts of the first user and the second user (or additional users beyond two in some cases) may take place automatically at the time of completion of the transaction. Thus, the step of automatically transferring funds between accounts may comprise automatically transferring funds between accounts of each of the users involved in the transaction split to accomplish the approved transaction split request.

Some implementations may further comprise receiving incoming transaction data; and automatically calculating split amounts based upon the approved transaction split request using the incoming transaction data. For example, the system may allow for uploading a receipt of the transaction and, based upon the agreed split amount/percentage, the system may automatically designate the transaction amount and allocate funds according to the agreed amount/percentage.

In another example of a method for collaborative money management between a plurality of users of a money management system according to other implementations, the method may comprise receiving a request to share an account from a first user of a collaborative money management system and receiving a response to the request to share from a second user of the collaborative money management system. Additional users may be involved in some implementations to allow for sharing of an account or sub-account by a plurality of users, such as employees in a company or members of an organization or family.

Responsive to an acceptance of the request to share by the second user of the collaborative money management system, a joint account may be established by the system under which the first user and the second user (or additional users) may fund and/or spend from the joint account. A set of rules under which each of the users of the joint account may fund and/or spend from the joint account may then be established. The method may further comprise receiving a request to authorize a transaction, which may be received from a user of the system on a mobile application or a web-based application under control of the first user. The system may then evaluate the set of rules to determine whether the transaction is authorized and, upon determining that the request to authorize the transaction meets each rule in the set of rules, authorizing the transaction and/or automatically transferring funds between virtual accounts of at least the first user and the second user (or additional users, as applicable) in accordance with the set of rules.

In some implementations, the joint account may comprise a primary account holder and one or more secondary account holders, wherein the step of establishing a set of rules is performed using rules set by the primary account holder.

In some implementations, the joint account may comprise a virtual account linked with a financial institution account.

In some implementations, the step of authorizing the transaction may comprise transferring funds to the joint account from the financial institution account. In some such implementations, the step of transferring of funds to the joint account from the financial institution account may take place at the time of the transaction.

In some implementations, the joint account may comprise a joint account of a company or other organization. In some such implementations, each of the users of the joint account may be employees of the company. The joint account may comprise, for example, a virtual account associated with a particular company project or a particular, jointly funded activity, such as a vacation.

In a specific example of a system for collaborative money management according to some embodiments, the system may comprise one or more processors and a computer readable memory operably coupled with the one or more processors. The computer readable memory may comprise one or more functional modules, such as software modules, which may comprise, for example, a transaction authorization module, which may be configured to receive a transaction split request from a first user of the collaborative money management system from a mobile application or a web-based application under control of the first user. The transaction authorization module may further be configured to send a transaction split request notification to a second user of the collaborative money management system and approve or deny the transaction split request. The transaction split request may comprise a total cost of a transaction and/or a proposed split of the total cost of the transaction.

The system may further comprise a transaction splitting module, which may be configured to, upon approval of the transaction split request, automatically transfer funds between accounts of the first user and the second user (or additional users in some embodiments) in the collaborative money management system to accomplish the approved transaction split request.

In some embodiments, the system may be configured to allow users to split transaction costs either before or after the transaction has taken place.

Some embodiments may be configured to allow users to pre-approve a transaction split. In some such embodiments, the system may automatically transfer funds between users of the collaborative money management system according to an approved transaction split at the time of the transaction.

In some embodiments, the transaction splitting module may be configured to automatically refund funds between accounts of the first user and the second user upon notification of a cancellation or refund of a transaction of an approved transaction split request.

The features, structures, steps, or characteristics disclosed herein in connection with one embodiment may be combined in any suitable manner in one or more alternative embodiments.

### BRIEF DESCRIPTION OF THE DRAWINGS

Non-limiting and non-exhaustive embodiments of the disclosure are described, including various embodiments of the disclosure with reference to the figures, in which:

FIG. 1 is a schematic diagram illustrating an example of a system for collaborative money management and money sharing amongst a plurality of users of a networked system according to some embodiments;

FIG. 2 is a schematic diagram illustrating various functions of a system for collaborative money management and money sharing amongst a plurality of users according to some embodiments;

FIG. 3 is another schematic diagram illustrating other functions of a system for collaborative money management and money sharing amongst a plurality of users according to some embodiments;

FIG. 4 is a flow chart illustrating an example of a method for sharing a spending account with one or more other users according to some implementations;

FIG. 5 is a flow chart illustrating an example of a method for executing a transaction using a shared spending account according to some implementations;

FIG. 6 is another flow chart illustrating exemplary steps involved in a method for splitting transaction costs with another user either before or after a transaction;

FIG. 7 illustrates addition steps and user interface elements involved in requesting a transaction split according to some embodiments and implementations;

FIG. 8 depicts an example of a user interface during a process for splitting the costs of a transaction according to some embodiments; and

FIG. 9 depicts another screen of an exemplary user interface according to some embodiments.

### DETAILED DESCRIPTION

A detailed description of apparatus, systems, and methods consistent with various embodiments of the present disclosure is provided below. While several embodiments are described, it should be understood that the disclosure is not limited to any of the specific embodiments disclosed, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

The embodiments of the disclosure may be best understood by reference to the drawings, wherein like parts may be designated by like numerals. It will be readily understood that the components of the disclosed embodiments, as generally described and illustrated in the figures herein, could be arranged and designed in a wide variety of different configurations. Thus, the following detailed description of the embodiments of the apparatus and methods of the disclosure is not intended to limit the scope of the disclosure, as claimed, but is merely representative of possible embodiments of the disclosure. In addition, the steps of a method do not necessarily need to be executed in any specific order, or even sequentially, nor need the steps be executed only once, unless otherwise specified. Additional details regarding certain preferred embodiments and implementations will now be described in greater detail with reference to the accompanying drawings.

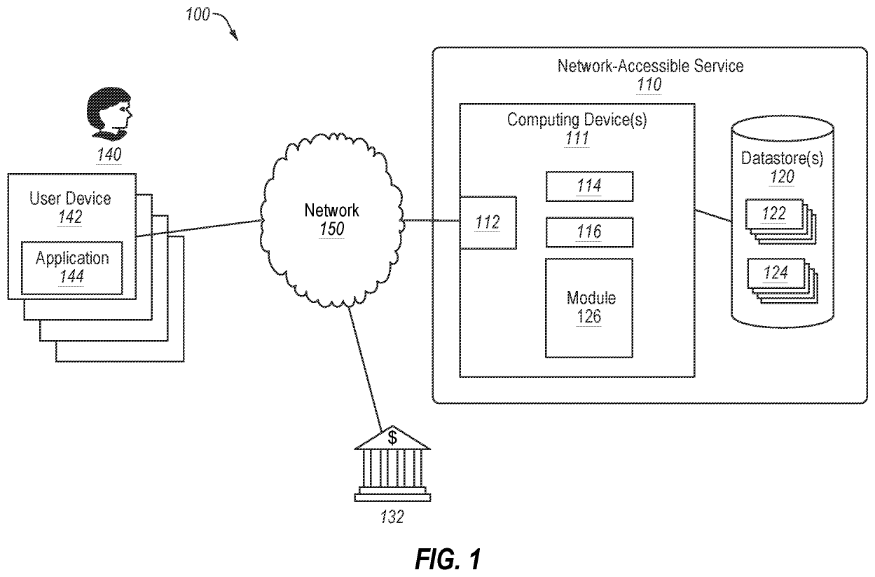

FIG. 1 depicts an example of a system 100 for collaborative budgeting, spending, and/or money management according to some embodiments. As shown in this figure, one or more client or devices, such as client device 142, may be configured to communicate with one or more computing devices over a network 150. In the depicted embodiment, users 140 may each operate an application 144, such as a mobile app operating on a smartphone or other user device 142, for example. Client devices 142 may communicate through network 150 network-accessible service 110, which may comprise various computers or other computing devices 111 (e.g., server computers). The computing device 111 may comprise a communication interface 112, on or more processor 114, and memory 116. The computing device 111 may comprise and/or be communicatively coupled to a datastore 120. The datastore 120 may be implemented using a database, directory, or other persistent data storage mechanism. Accordingly, the datastore 120 may comprise a non-transitory machine-readable storage medium, such as a hard disk, non-volatile memory, or the like. One or more operational modules 126 may be configured to cause processor 114 to take various steps in accordance with one or more aspects of various embodiments of the invention disclosed herein.

The datastore 120 may store user account information in user account records 122 for users 140 of the system 100. Each user account record 122 may include user profile information, such as a username, contact information (e.g., email address, telephone number, etc.), account balances, etc. Additional information may be stored in a set of user rules 124, which may comprise, for example, virtual account/spending categories, user created rules for sharing virtual spending accounts, and the like, for example. In some embodiments, user rules 124 may be stored in user account records 122.

In some embodiments, computers and/or systems of one or more banks or other financial institutions 132 may be coupled via network 150 to network-accessible service 110. For example, each of the users 140 may have a bank account or an account at another financial institution that may be used to fund accounts created through application 144, which, again, may comprise a mobile app running on a smartphone, a Web-based application, or the like. Client devices 142 may therefore comprise any computing device suitable for implementing the inventive systems and/or methods described herein and preferably comprising a processor, including but not limited to a personal computer, a laptop computer, a desktop computer, a notebook or tablet, a smartphone, and the like.

Communication between the client device(s) and the server(s) may take place over a network 150, which may comprise, for example, the Internet, a local area network, a virtual private network, a mobile network, and/or any other communication network utilizing one or more electronic communication technologies and/or standards (e.g., Ethernet or the like). Information pertaining to the system 100 may be presented to various clients/users in an application 144 operating on a client/user device 142. This application may comprise, for example, a general-purpose web browser application, a special-purpose application, such as a mobile phone application, or the like.

Each client/user device 142 may comprise various modules, elements, or other functional sub-parts configured to implement various aspects of certain embodiments of the invention as desired.

In some embodiments, authentication steps may take place and/or be provided between network-accessible service 110 and one or more user devices 142. Authentication may take place by any means known or otherwise available to one of ordinary skill in the art, such as by use of passwords, a digital signature, biometrics, or other credentials provided by users.

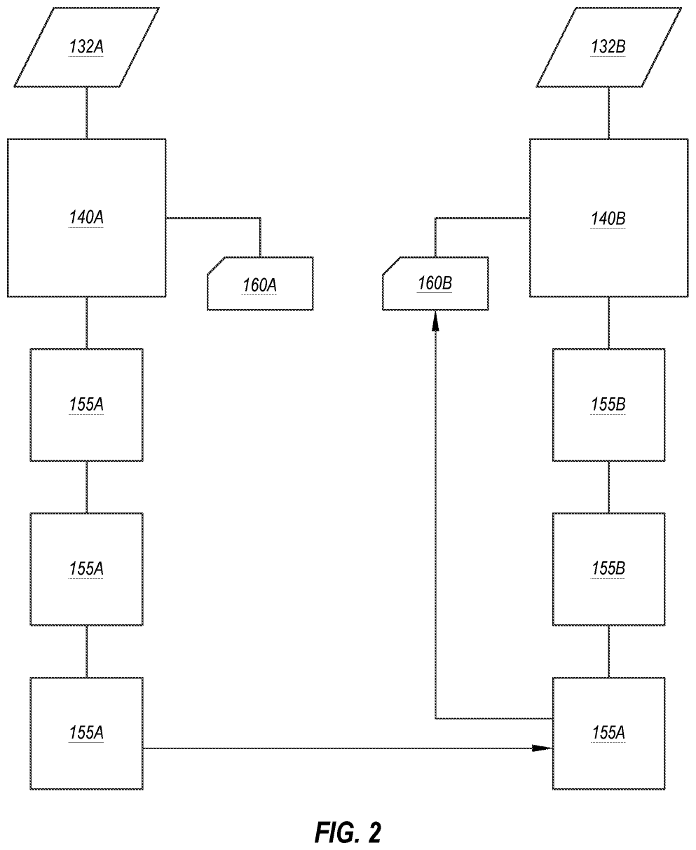

FIG. 2 is a diagram depicting certain aspects of system 100 during operation. More particularly, FIG. 2 depicts two users, user 140A and user 140B. Each user may, as previously mentioned, operate an application, such as a mobile app on a computing device, such as a computer or mobile smartphone, and may be issued an account on a system accessible via the application. Each user may also be issued a debit card or another payment means 160 (debit card 160A is issued to user 140A and debit card 160B is issued to user 140B). As explained in greater detail below, by funding and sharing various virtual/sub-accounts, user 140B may be able to spend from a virtual account of user 140A, and vice versa, using their own card or another single means for payment without having to be given physical access to a card or other payment means of user 140A.

It should be understood that, although debit cards are issued for purposes of illustration in the embodiment depicted in FIG. 2 that, in alternative embodiments, other means for payment may be issued to one or both of the users, either in addition to a card or in lieu of a card. Examples of such alternative means for payment include mobile wallets or other mobile payment systems, other cards, and the like. Any form of payment that can be linked with an account holder and used to effectuate payment during a transaction, such as a transaction at a point of sale or a transaction over the Internet for example, should be considered within the scope of the present disclosure.

Users/accounts 140A and 140B may be linked, either temporarily or permanently, with an account at a bank or other financial institution. Thus, user 140A has an account at financial institution 132A and user 140B has an account at financial institution 132B, both of which may be used to fund an account with system 100, fund one or more virtual and/or sub-accounts, and/or replenish such funds as needed. In alternative embodiments and implementations, however, it is contemplated that the accounts used by system 100 may be financial institution accounts or may be operated by a financial institution, in which case the financial institution may operate, wholly or in part, system 100 and thus a link to an independent financial institution may not be required. In addition, it should be understood that some users of system 100 need not have an account with a bank or another financial institution at all. For example, a scenario in which a parent shares money with a child is discussed below. In this scenario, the child may be a user of system 100 but may not have a bank account.

Users/accounts 140A and 140B may have a plurality of virtual or sub-accounts 155 associated with their respective accounts. Each of the virtual and/or sub-accounts 155 may have a spending category associated with it and/or an amount. Thus, user 140A has a series of virtual/sub-accounts 155A and user 140B has a series of virtual/sub-accounts 155B.

The spending categories of each virtual/sub-account may be preassigned, assigned by the user, or may comprise a combination of pre-assigned categories and user-assigned categories. Examples of spending categories include vacation, food, clothing, mortgage/rent, utilities, recreation, etc. An amount may also be associated with each virtual/sub-account, which amount may indicate a limit to which the user may spend within the virtual/sub-account 155 during a predefined time period, such as per month. In some cases, the spending amount may lack a predefined time period, however. For example, a user may set up a virtual/sub-account for a particular event, such as an upcoming vacation, that, once depleted, will not be renewed.

As indicated by the arrow in FIG. 2, a user may share, either temporarily or permanently, one or more of the virtual/sub-accounts 155 with another user. Thus, one of the virtual/sub-accounts 155A has been shared with user 140B. By sharing this virtual/sub-account with user 140B, user 140B can spend from this virtual/sub-account using his or her debit card 160B, for example, subject to any rules/restrictions placed on the shared virtual/sub-account. Thus, for example, let us assume that user 140A is a parent and user 140B is a child and parent 140A wishes to provide funds for child 140B to go grocery shopping. A “Grocery” virtual/sub-account may then be shared with child 140B to allow child 140B to spend from this virtual/sub-account. It should also be understood that, although not indicated in the diagram of FIG. 2, in some embodiments and implementations, user 140B may share one or more virtual/sub-accounts with user 140A, either in addition to or as an alternative to the sharing indicated by the arrow in FIG. 2.

A wide variety of rules may be put in place for account/funds sharing. For example, with reference again to the example of the parent/child, a threshold spending amount may be placed on the shared virtual/sub-account. This threshold may, for example, default to a limit that may be assigned by the user prior to sharing or the user may apply a more restrictive limit to the shared portion of the account than was applicable to the user himself prior to sharing. Thus, if parent 140A wishes to limit child 140B's spending to $100, this limit may be added to the shared virtual/sub-account as a rule. This limit may be the limit applied to the virtual/sub-account for any user or may only be applied to the shared user. In other words, a $100 spending threshold may be applied to the virtual/sub-account so that even user 140A may be limited to this spend amount or, alternatively, a higher spending threshold may be applied to the virtual/sub-account than to the shared virtual/sub-account.

Examples of other rules include time limitations. For example, user 140A may only share one or more virtual/sub-accounts with user 140B and/or other users for a threshold time period. Any funds from the shared funds that have not been spent within the threshold time period may then remain in the account to be spent by the sharing account holder—i.e., user 140A in this example. Thus, for example, user 140A may set a time limit of 24 hours, or until the end of the current day, within which the shared funds/account may be active, after which the account may revert to sole control of the original account holder. Rather than giving someone a certain amount of money and then requiring change, if any, following the transaction, a user can allow others to spend what they need to, within whatever limits have been placed on the funds, without requiring change to be given to the sharing account holder following the transaction or transactions.

Some sharing options may be limited by transaction. In other words, in some cases, a shared account may only be shared until a single transaction (or a predetermined number greater than one) has taken place, after which the account may be removed from view/spending control of the user being shared with.

As another potential rule option, it is contemplated that, because certain preferred embodiments and implementations may be implemented using smartphones that typically have GPS/location receivers/sensors built therein, some rules may only allow spending to take place at a certain location, or within a certain geofence. In some cases, rules may spell out specific vendors/merchants for which spending may be authorized, either in addition to or as an alternative to location-based rules that rely on geolocation technology. Categories of vendors or types of purchases may also be put in place as a rule. For example, a user may specify that funds may only be used for gasoline or may only be used at fast food restaurants.

The initiation of sharing an account may take place in a variety of ways. For example, the user may select the account and the user(s) to whom the user wishes to share the account, allow with any rules/restrictions about the sharing, and then the users being shared with may then receive a notification indicating that an account has been shared with them. As another example, other users may request that a particular account be shared and/or a particular amount be shared, after which the user receiving the request may be prompted to either accept, deny, or alter the request before accepting.

In certain preferred embodiments and implementations, sharing is configured to take place on a per-transaction basis. In other words, in order to force each user to contemplate each purchase, in some embodiments and implementations, users may be required to take deliberate action to re-share an account following each transaction before additional purchases may be made using a card (or card number via a mobile wallet or the like, for example) of the user to which the account had previously been shared. Again, this deliberative, transaction-by-transaction methodology may be useful to impose good spending habits. However, it is contemplated that in certain other implementations, a user may be allowed to set a spending limit within a particular category/account and share this account with one or more other users without restriction on the number of transactions.

In some embodiments and implementations, no actual funds may be transferred between accounts, or between sub/virtual accounts, until a user attempts to make a transaction. In other words, at the time of sharing a virtual/sub-account with another user, the user being shared with may see that he or she has a certain amount of money in a certain spending category that has been shared with them, but system 100 may wait until that user attempts to spend from the shared funds before transferring them.

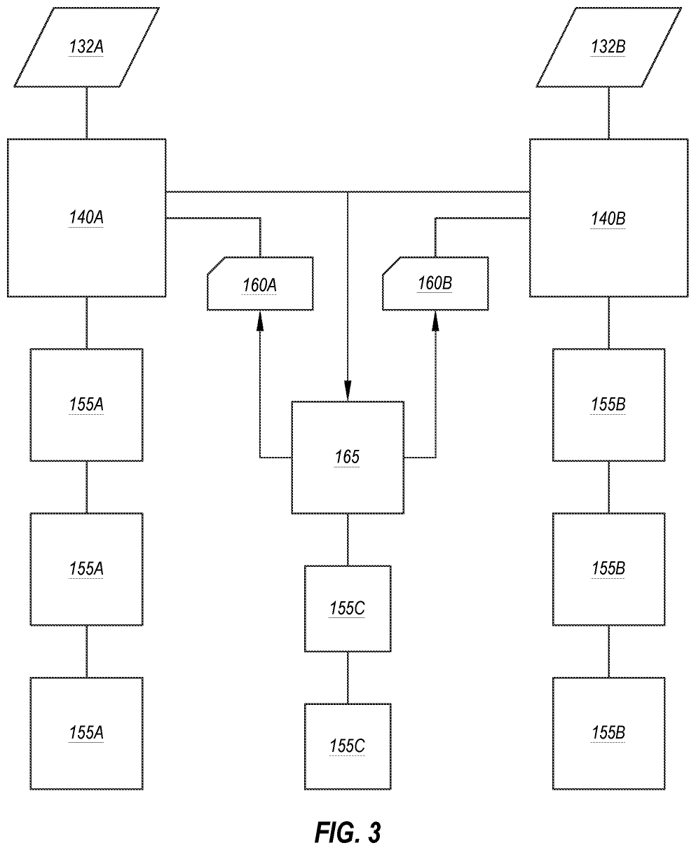

FIG. 3 is a diagram depicting certain aspects of system 100 during operation according to other implementations and embodiments. More particularly, FIG. 3 again depicts users 140A and 140B, each of which again may be issued payment means 160 (spending/debit card 160A issued to user 140A and spending/debit card 160B issued to user 140B), and one or both of which may have a linked account to a financial institution 132A/132B. However, as will be more apparent after reviewing the disclosure below, in some embodiments and implementations, only a single financial institution account may be used rather than the two depicted in FIG. 3. For example, in embodiments involving companies or other organizations, a single account from the organization (or multiple accounts) may be used to fund a shared sub/virtual account 165 that may be accessed by a plurality of employees or other members of an organization. As indicated in FIG. 2, each user of the system depicted in FIG. 3 may establish a series of virtual/sub-accounts 155A/155B, which may contain various information, such as spending categories, amounts, etc.

However, unlike the implementation shown in FIG. 2, FIG. 3 also depicts a shared account 165, which may also be a virtual account. In this example, rather than one user sharing a virtual/sub-account with another user, an account 165 is created that both user 140A and user 140B may fund. Account 165 may be permanent or, like the sharing of other virtual/sub-accounts, may be temporary. Account 165 may also have a series of rules associated with it, which may establish, for example, when, how much, and under what circumstances funds in the account may be spent by each user. It should also be understood that account 165 may be shared with more than two users in some embodiments and implementations.

Although not required, it should be understood that the sharing of account 165 would typically be more permanent than the sharing of accounts by user 140A with user 140B (or vice versa) depicted in FIG. 2. Thus, for example, unlike the sharing depicted in FIG. 2, in some embodiments and implementations, each user with which account 165 is shared may be considered joint owners or users of the account. In addition, although not required, the shared account 165 of FIG. 3 may also, unlike the sharing depicted in FIG. 2, require contributions from two or more users to the funding of the account.

Shared accounts 165 may in some cases contain a spending category. For example, if two or more users decide they want to plan a vacation together, they may establish a shared account 165 that each user contributes a set amount each month into. The account may then keep track of the funded amount, in some cases also tracking individual contributions of each user. A possible spending rule may then disallow any and all spending until a threshold amount has been contributed by all users. For example, using the vacation example again, if $10,000 is needed in order to take the vacation, spending by all users may be prohibited by the system until $10,000 is funded within shared account 165.

Permission options may also be built into system 100. For example, using the shared account 165 feature as an example, one of the users contributing to the shared account may wish to spend from the account but be unable to absent the permission of one or more (in some cases, all) users contributing to account 165. Thus, the user wishing to spend from the account may trigger a message to one or more of the other users to request permission to spend. This permission may take place at the point of sale or prior to the point of sale, as desired. The trigger may be a formal request from the user indicating the amount and/or purpose of the contemplated purchase, or may be triggered by other events, such as an attempt to complete a transaction using the shared account 165.

Similar permission options may be used in the context of the scenario depicted in FIG. 2 as well. For example, user 140B may request permission from user 140A to share in a particular account and/or to spend a particular amount. The acceptance of this request from user 140A may result in the sharing depicted in FIG. 2.

System 100 may also have a hierarchy of users available, each with different features and capabilities within the system. For example, as alluded to previously, a primary account holder may be a first parent or both parents. A second parent may be an administrator of the account and may therefore have many, but not all, of the capabilities/options as the primary account holder. Child or other lesser accounts may also be available, which may have more limited options. For example, a child may only be able to request or accept shared accounts from a higher account holder.

Some embodiments, such as embodiments having both permission aspects and a hierarchy of users for example, users may request access of funds from one category or sub/virtual account 155 to another. Thus, for example, a partner of a primary account holder 140 may request that funds in a vacation sub/virtual account 155 be accessed for use in another category/account. The system may allow one user to request such access from another user at a higher level in the user hierarchy. If desired, however, each user, or a subset of the users, may be given the ability to transfer funds between sub/virtual accounts 155 without requesting access.

Similar hierarchical structures may be put in place for businesses or other organizations. For example, a primary account holder of a business account may be a manager or owner of the business and employees may have accounts with similar capabilities and options to a child account in the family scenario. Thus, a manager may create a virtual account for a particular project, for example, and may fund this account and provide access to employees on the project team. Some employees may be able to spend more than others, as may be prescribed in rules established by the primary account holder.

Similarly, a shared virtual account may be created by two managers of two separate departments, which fits better within the scenario shown in FIG. 3. Both managers may fund the account with money from their own, separate budgets and may establish rules under which the other manager and/or the downstream employees may spend from the shared virtual account.

FIG. 3 also depicts the possibility of having not just a plurality of users access the shared account 165, but also the possibility of having a plurality of spending categories 155C within the shared account 165. Thus, although in some cases account 165 may contain its own category for purposes of spending and therefore may not have sub-categories, in other cases account 165 may designate an overall spending purpose, such as a particular project involving two departments, but then spending within the project may involve use of sub-categories, such as advertising, travel, supplies, etc., each of which may be part of one of categories 155C.

Rules may be set up at the level of account 165 and separately, if desired, at the level of 155C, if this level is used. Spending limits, user limits, time limits, geographical limits, merchant restrictions, etc., may be applied to account 165 as a whole, and additional restrictions/rules may be applied within each sub-category 155C. For example, an overall spending limit of $10,000 may be applied at level 165, and spending limits of $5,000 each may be applied to categories 155C.

Preferably, each user of the system has their own card/spending account number so that, by using a mobile application or web-based application interface, for example, every user of the system may use their own card without having to borrow/exchange cards, to spend using their own card according to the established rules. Changing of the rules/restrictions may, again, be based on a hierarchy and may be done using the application so that rule changes and/or sharing/unsharing of funds/accounts takes effect immediately upon input of such changes.

In some embodiments and implementations, the system may also track all expenditures made by each user within each category. This may replace the need for company expense reports, employee reimbursements, and accounting splits, for example.

Sharing may also be done using a wider basis in some embodiments. For example, in any of the previously described implementations, a user may decide to share multiple accounts/categories with one or more other users. As a more specific example, a group of accounts/categories may be created for “household expenses.” The individual categories/accounts falling within this group may comprise, for example, groceries, home improvement, utilities, etc. Instead of sharing just one of these categories/accounts, a user may decide to share all of them with another user, subject to any of the rules/restrictions described herein or other similar rules/restrictions available to those of ordinary skill in the art after having received the benefit of this disclosure.

In addition, it should also be understood that the system 100 may be configured such that each user has his or her own financial institution account with funds that can be transferred to an account, such as a virtual account, of the system 100. However, in some embodiments and implementations, some users may have a lesser account type that may not require a bank account. For example, some users may join and set up an account with system 100 for the purpose of receiving shared funds/accounts from other users without themselves being able to share funds/accounts or establish jointly funded accounts, as depicted in FIG. 3.

In some preferred embodiments and implementations, each user may have a card/spending account that defaults to inactive/unfunded such that a user cannot use the card/spending account for transactions unless specific, purposeful actions are taken beforehand. For example, in some cases, a user must select a particular account/category, which may comprise a sub-account and/or virtual account having a spending category, at or before the time of the transaction in order for the card to activate, be funded, or otherwise be capable of completing the transaction. In the case of a user spending from an account shared from another user, the sharing user must, in some implementations, both share the account with the user and must designate a category and, in some cases, a dollar amount or maximum dollar amount for the transaction in order for the card to be made capable of completing the transaction. In some cases, a time limit may be placed on the transaction after designating a category and/or amount for the transaction. In other words, the transaction must, in some embodiments, take place within an hour or the card/spending account will default to zero/non-usable.

However, with respect to certain types of transactions, such as recurring monthly transactions, a user may simply designate a category and recurring spending amount and may be able to use the card for this purpose within each of the recurring periods without the card defaulting to non-usable. The user may also be able to share funds with another user using this same premise. In other words, a first user may share a sub-account with another user each month (or any other recurring period) by sharing the account and designating rules, such as a threshold amount, spending category, and maximum number of transactions per period, for example.

As additional optional features of system 100, in some embodiments, each user, or a subset of users depending upon their user type in a hierarchy of users, may be able to communicate with one another, take photographs of receipts and share them with other users and/or store them in a data file linked to a particular transaction, and/or provide updates to an activity log, which may be shared with other users, either automatically or manually and either via the application itself or via another social media network, for example. Text messages may also be sent, which may allow users to communicate with one another about transactions within the system or otherwise. For example, in addition or as an alternative to an automated request for sharing of funds, a user may send a personalized message asking another user to share funds and/or an account that may contain more details about the purpose for the transaction or any other information as desired.

The application may also be configured to access various sensors/receivers of a mobile smartphone or the like. For example, in order to complete some transactions having location and/or merchant restrictions, the phone may access a GPS receiver and the application may require a geographical match, such as being within a particular geo-fenced region or within a certain distance of a particular merchant, in order for the card/spending account to be capable of completing a transaction.

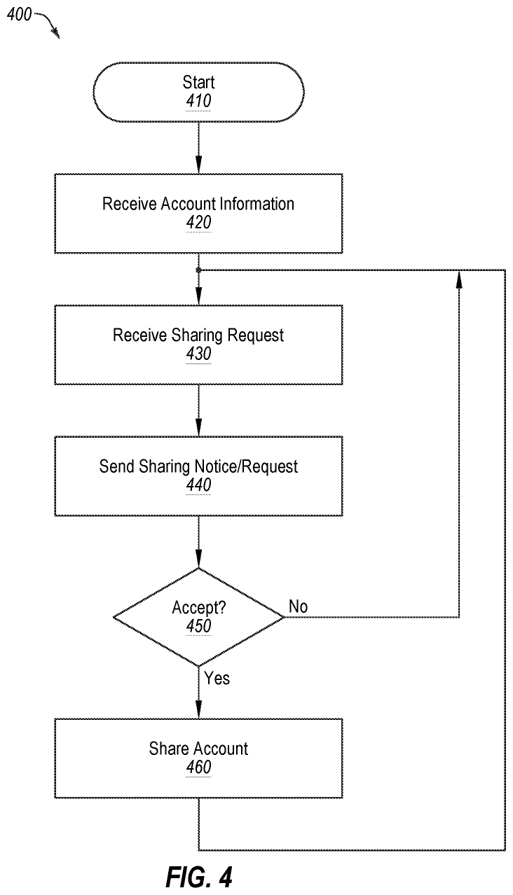

FIG. 4 is a flow chart illustrating one example of a method 400 for sharing a spending account with one or more other users is illustrated. At step 410, the method 400 starts and is initialized. Steps of the method 400 may be implemented using machine-readable instructions stored on a non-transitory, machine-readable media (e.g., hard disk, non-volatile memory, etc.), such as machine-readable instructions stored within a mobile smartphone, tablet, or other computing device. Step 410 may, therefore, comprise loading one or more machine-readable instructions for execution by a processor of the smartphone/computing device. Steps of the method 400 may be tied to particular machine components, such as computing resources (e.g., a processor, memory, etc.), data storage resources (e.g., database, datastore, etc.), communications interfaces (e.g., network interfaces), human-machine interface components, and the like. Accordingly, step 410 may comprise allocating and/or initializing machine components.

At step 420, information pertaining to an account, such as a user account, virtual account, and/or sub-account, is received. In some implementations, this information may be input using a mobile application on a mobile smartphone or a web-based application, and may be received at a server, such as network accessible service 110 of FIG. 1. Information used to establish this account may include, for example, usernames, contact information, financial institution account information, passwords, and the like. For establishment of sub/virtual accounts, step 420 may comprise receiving information about the spending category of the account, threshold spending amounts, rules, restrictions, and the like, as described throughout this disclosure.

At step 430, a request may be received to share an account with another user. The request may be received from the user desiring to have an account shared with them or, alternatively, may be received from the user desiring to share an account with another user. In instances in which a request is received from a sharing user, the request may contain rules and/or restrictions for the sharing, such as spending limits, a category for the account to be shared, geographical restrictions, merchant restrictions, and/or temporal restrictions, for example.

After receiving the requisite request and establishing information sufficient to notify a user of the request, the system may send a notification or request to one or more users about the sharing request at step 440. For example, if a user has requested to have an account be shared with them, the user to whom the request was made may receive a request from the system to either accept, deny, or modify the request. If the request was made by the user having the account to be shared, the system may notify the requesting user, and in some cases may also notify the user with which the account is being shared, regarding the account that has been shared.

In implementations involving a request from one user that can be accepted or denied by a second user, the system may receive an indication at step 450 as to whether the request has been accepted. If the request is denied, method 400 may revert to step 430, or any other previous step, without providing access to any additional accounts. If the request was made by a sharing user, step 450 may be omitted.

If the request is accepted by the user to which the request is being made, or if the request was made by a sharing user, method 400 may proceed to step 460 at which point the account may be shared with one or more users according to the request. In some implementations, step 460 may comprise sending notifications to each user that has been granted sharing privileges. This notification may include, for example, the type/category of the account, any spending restrictions, any other rules or restrictions associated with the shared account, and/or an explanation of the steps required to complete transactions using the shared account.

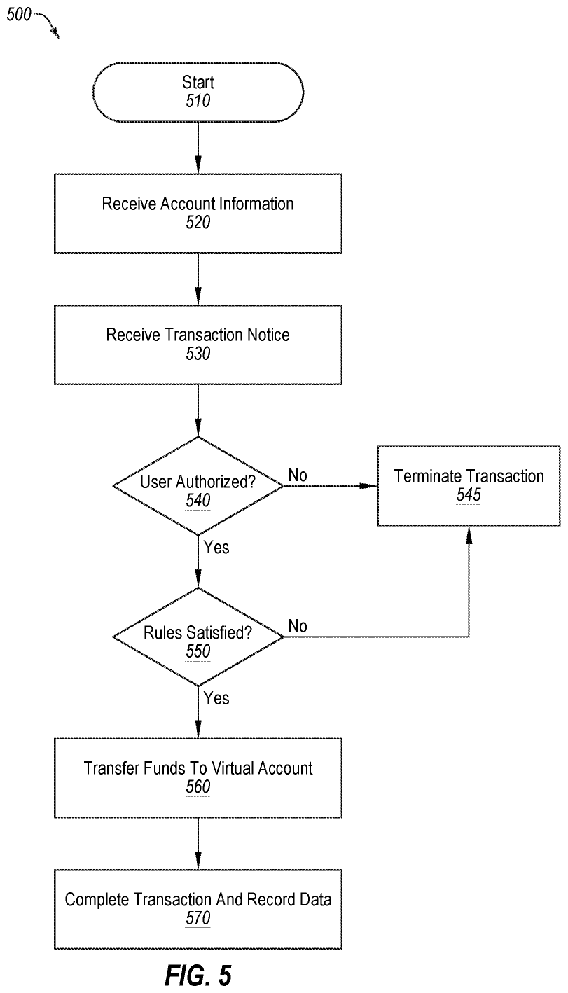

Another flow chart is presented in FIG. 5, which is an example of a method 500 for executing a transaction using a shared spending account. At step 510, the method 500 starts and is initialized. Once again, one or more of the steps of the method 500 may be implemented using machine-readable instructions stored on a non-transitory, machine-readable media (e.g., hard disk, non-volatile memory, etc.) and step 510 may therefore comprise loading one or more machine-readable instructions for execution by a processor of the smartphone/computing device. Similarly, steps of the method 500 may be tied to particular machine components, such as computing resources (e.g., a processor, memory, etc.), data storage resources (e.g., database, datastore, etc.), communications interfaces (e.g., network interfaces), human-machine interface components, and the like.

At step 520, account information may again be received. Like step 420, this step may comprise establishing an initial account or a new virtual/sub account, which may include a virtual/sub account initially only accessible by a single user or a shared account including contributions from multiple users, as illustrated in FIG. 3. In some implementations, step 520, or another related step, may comprise receiving and/or sending notifications that one or more accounts have been shared between users and updating system information to account for the sharing and any associated rules.

At step 530, a notification may be received indicating that a user is attempting a purchase/transaction using a card/account of the system. Thus, this notification may be triggered when a physical card of a user of the system has been swiped, or otherwise a spending account of a user has been triggered (via electronic payment or mobile wallet, for example), by a merchant. Thus, typically, although not exclusively, the notification of step 530 is received from a merchant associated with the transaction attempt.

Because the notification of step 530 will identify the user attempting a transaction, a check may be made at step 540 as to whether the user is authorized to make the transaction. For example, step 540 may comprise identifying the user within the system and checking one or more account balances to determine whether the user can complete the transaction. If the account being used for the transaction is a shared account, step 540 may further comprise determining whether the account is currently being shared with the user attempting the transaction. If the user is unauthorized, the transaction may be declined/terminated at step 545. If the user is authorized, method 500 may proceed.

Other checks may also be made to ensure that no rules/restrictions on the account are being violated by the attempted transaction. Thus, step 550 may comprise evaluating all such rules/restrictions associated with the account and user by the user attempting the transaction and/or the user sharing their account with that user. These checks may include any of those previously mentioned. It should be understood that this step may be combined with step 540 in some implementations but is being shown separately for purposes of illustration. If one or more rules are being violated, then the transaction is declined/terminated at step 545.

If, on the other hand, the rules/restrictions are not being violated, funds may be transferred to the card/account to fund the transaction. Thus, in some preferred embodiments, the funding may take place at the time of the transaction. In other contemplated embodiments, however, funding may take place at other stages, such as upon confirmation of a share request, for example. However, it may be preferred to configure the system to transfer funds only at the time of completion of a transaction, which may carry a number of benefits. For example, in this way, should a user's card be lost or stolen, no spending may take place using the card alone, given that the application must be used along with the card to complete any transactions.

In implementations in which the user attempting the transaction is using a shared virtual account, funds may be transferred from a bank account or other financial institution account of the sharing user.

Following transfer of funds, the transaction may be completed at step 570 to allow the user to obtain the desired goods or services using the application and card/spending account. In addition to completing the transaction, in some implementations, data from the transaction may be recorded and used alter account configurations to account for the transaction and/or provide details of the transaction for record keeping. In implementations requiring a deliberate action by one or more users prior to each transaction, step 570 may further comprise returning control of the account used to fund the transaction to the user associated with that account. Thus, any change from a transaction resulting from an account being temporarily shared with another user may immediately be returned to the sharing user upon completion of the transaction without requiring any further action from the users.

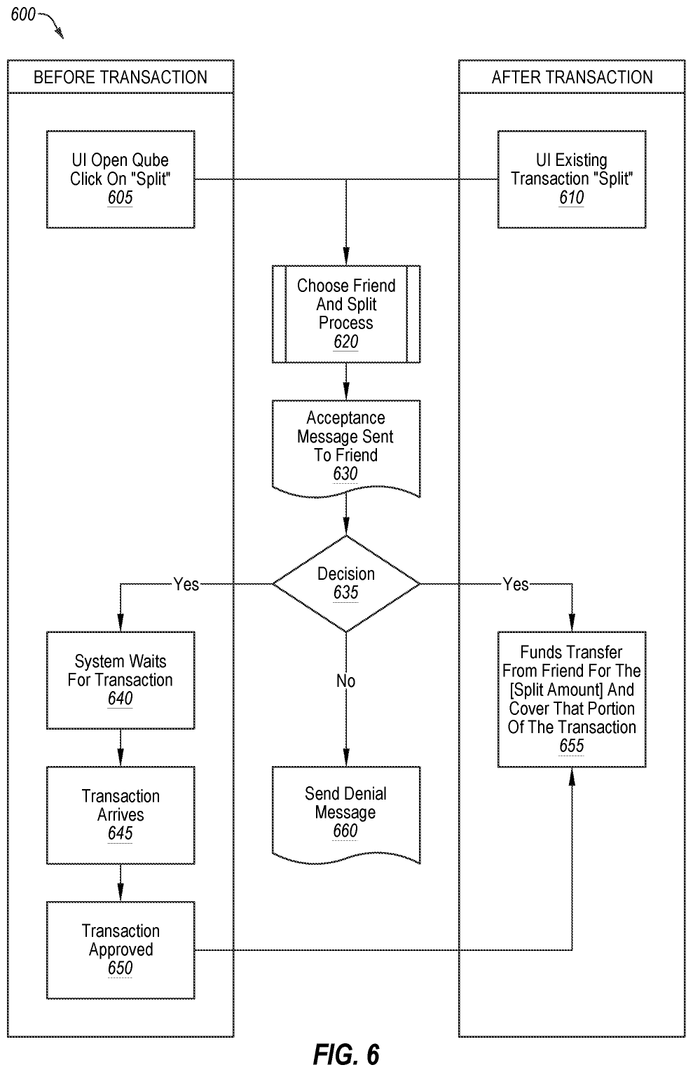

FIG. 6 illustrates an example of a method 600 for splitting the costs of a transaction with another user of a collaborative spending system. Again, one or more of the steps of the method 600 may be implemented using machine-readable instructions stored on a non-transitory, machine-readable media (e.g., hard disk, non-volatile memory, etc.). Similarly, steps of the method 600 may be tied to particular machine components, such as computing resources (e.g., a processor, memory, etc.), data storage resources (e.g., database, datastore, etc.), communications interfaces (e.g., network interfaces), human-machine interface components, and the like.

In some preferred implementations of method 600, users can split/share a transaction on a transaction-by-transaction basis. In other words, users may share the cost of a single transaction, either before or after the transaction has taken place. In some cases, this may be done at or just prior to the transaction and may therefore address the problem of splitting lunch or other one-off transactions with one or more users.

Typically, for two people to split a transaction, several systems are used. One system, for example, may be used for the payment and another, such as Venmo, PayPal, or Zelle, may be used for the reimbursement. This may be done via a payment request method whereby one person makes a request to the other party for a certain amount. However, these methods are typically done independently from the actual transaction and therefore create a debtor scenario between two or more parties to a transaction.

Using the split transaction methodology, an example of which is illustrated in FIG. 6, however, a user may be able to select one or more other users with whom a transaction is to be split/shared, in some implementations either before or after the transaction has taken place. Thus, a first user may open an app or other software program and click on or otherwise select an option to “split” an anticipated transaction at step 605. Alternatively, a user may select a transaction that has already taken place and/or select an option to split the existing transaction at 610. In either scenario, the originating user may start the split option in the app, for example, by tapping a “split” button and, in some cases, by adding one or more other users to the proposed split at 620. The other users may then receive a request message in their respective apps at step 630.

The requestees may then be prompted to accept or reject the proposed split at step 635. In some embodiments and implementations, a user may approve of the proposed split by tapping or otherwise selecting an “approve” button or the like, in some cases followed by choosing an account from which the funds for splitting the transaction will take place. Of course, the other users may, in some embodiments and implementations, alternatively decline the proposed transaction split if desired, at which a message may be sent to the original requesting user at step 660. Various acceptance/rejections messages may be automatically sent to other users upon requesting, accepting, and/or denying a request as desired.

The “before transaction” branch of the method may allow the originating user to collect authorizations to pay the full payment amount without having to pay it himself all up front. In other words, if all of the requested authorizations are approved before the transaction posts then the split amount of the transaction may be automatically transferred from each of the other users (such as from a financial institution account or an account of the system used to implement method 600) to complete the full transaction at the same moment that the transaction is being paid. Thus, in some embodiments and implementations, an approval of the purchase transaction and a transfer from each of the other users to the originating user may happen simultaneously, or at least happen at times close enough to one another to appear simultaneous to each of the users.

Thus, with reference to the left branch of method 600, if the transaction has not yet taken place but each of the users has approved of splitting the transaction, the system may be configured to await confirmation of the transaction at 640. Once the transaction arrives (step 645) and is approved (pending verification of funds; step 650), the funds may automatically transfer at step 655, preferably at or at least substantially at the same time as the transaction takes place. Thus, from the users' perspectives, all of the users contributed equally (or, if desired, unequally according to how the users agree to split the transaction) to the transaction and the funds are allocated between each user towards the transaction immediately before or at the time of the transaction.

Initiating the split after the transaction (the right side or “after transaction” branch of method 600) may be used to create a simple “reimbursement” or “request” for the split amount. Once the other user or users has approved the transaction and/or proposed split amount, the funds from each such user may be immediately transferred from the contributing user(s) to the originating user who has already paid for the transaction at step 655.

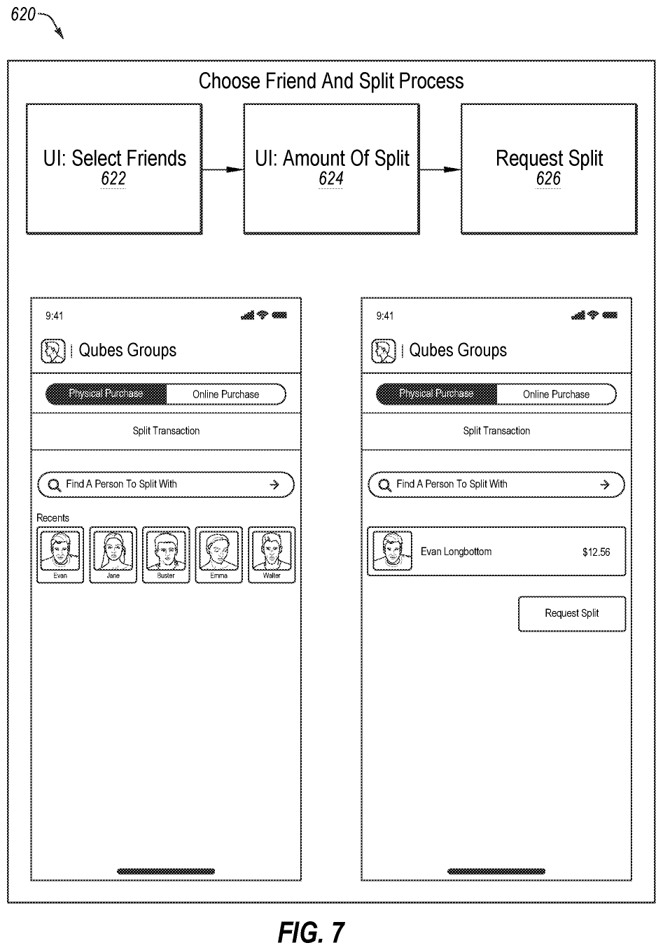

FIG. 7 illustrates some exemplary sub-steps that may be considered part of step 620 in some implementations. In particular, the user interface of the app or other software may be used to allow the requesting user to select one or more other users at step 622 for splitting a transaction (again, either before or after the transaction takes place).

The requesting user may then enter a proposed amount of the split at step 624. The app may, in some embodiments, be configured to allow a user to select an “even” split, at which point the app will automatically calculate the split amount based upon the transaction amount, which may be entered manually, receiving from incoming transaction data, selected from a list, scanned, or otherwise selected by the user, along with the number of splitting users. The software may, in some cases, also allow users to propose uneven splits as desired, either by dollar amount or percentage, for example. The request, which may include the dollar amount, percentage, full transaction amount, category for the transaction, and/or number and/or identify of other users involved in the split, may then be send at step 626.

Examples of screenshots from a user interface are also shown in FIG. 7. As shown in these screenshots, a user may be able to select either an online purchase or a purchase at a physical location. For online purchases, the app may be configured to allow a user to open a browser or other window to select the item or items to be purchased in the transaction during the splitting process. The app may also be configured to allow the user to select from a number of other users, such as by searching for names of other users throughout the system or by selecting from a list of “friends” (e.g., users that have been linked together in some way other than simply being users in the same system).

Once a user has been selected, an amount of the proposed split may be displayed, as shown in the user interface screenshot on the right. Again, the amount may be automated if the split is to be even or may be adjustable by the user if the split is to be uneven for some reason.

As a more specific example of a transaction split prior to the transaction, let us assume that two couples want to split the ticket costs for a show. A first user (user 1) may go online to purchase the tickets for the group and wants to ensure they all sit together. Thus, it is desirable that a single transaction be used to purchase all four seats. User 1 may then open his app and select “split.” In some embodiments, User 1 may first open one of the accounts referenced in connection with one of the earlier embodiments, such as a virtual accounting having a particular spending category, and may use this account both to fund the split transaction and, in some cases, to categorize the transaction as well.

User 1 may then select another user (user 2)'s name from a list of friends/users as displayed in the app. User 2 may then receive a push notification to authorize the request. This notification may, for example, be something along the lines of “User 1 wants to split a transaction—Approve?”. The request may also contain other information if desired, such as, for example, the amount of the full transaction, the amount that User 2 will have to contribute if the request is approved, the category for the transaction, the vendor for the transaction, the location of the seats, etc. The system may default to an even split of the transaction for simplicity but, as mentioned above, may allow for requests of uneven splits if desired.

Upon being notified that User 2 has accepted the proposed split, user 1 may then run a card, such as a debit card that may be issued to each, or at least a subset, of users of the system, as previously mentioned, to finalize the transaction. As the transaction is approved, money may be moved from user 2's account to user 1's account and half of the transaction may be ledgered to both users in their respective accounts. In this manner, user 1 can complete the transaction without ever having to become a creditor to user 2.

As another example involving a proposed split of costs for a show after the transaction to purchase the tickets has taken place, user 1 may purchase the tickets for the group and the transaction may post to his ledger. He may then tap on or otherwise select the preexisting transaction and may then select “split” (or the like), thereby allowing him to again select user 2 from a list of users/friends. User 2 may then receive a request notification, such as “User 1 wants to split a transaction from [merchant name] for [half of transaction amount]—Approve?”. Upon approving the request, the funds may be immediately transferred to user 1. In some embodiments and implementations, the transaction may also be accounted for automatically by the app, such as by offsetting the debited amount of the transaction in user 1's ledger. An equal transaction for half the amount may be automatically posted in the ledger of user 2.

In some embodiments, the system may be configured to automatically apply refunds to each user according to the original split. In other words, using the examples referenced above involving two coupling splitting the costs of a show, let us assume that the show is cancelled before it takes place and the costs of the tickets are refunded to the user who initiated the original transaction (i.e., user 1). In certain preferred embodiments, the refund may be automatically linked to the split and refunded to each of the users according to the split amount/percentage. Thus, in the event that the show is cancelled, half of the transaction cost may be automatically refunded back to user 2 as soon as it hits the account of user 1.

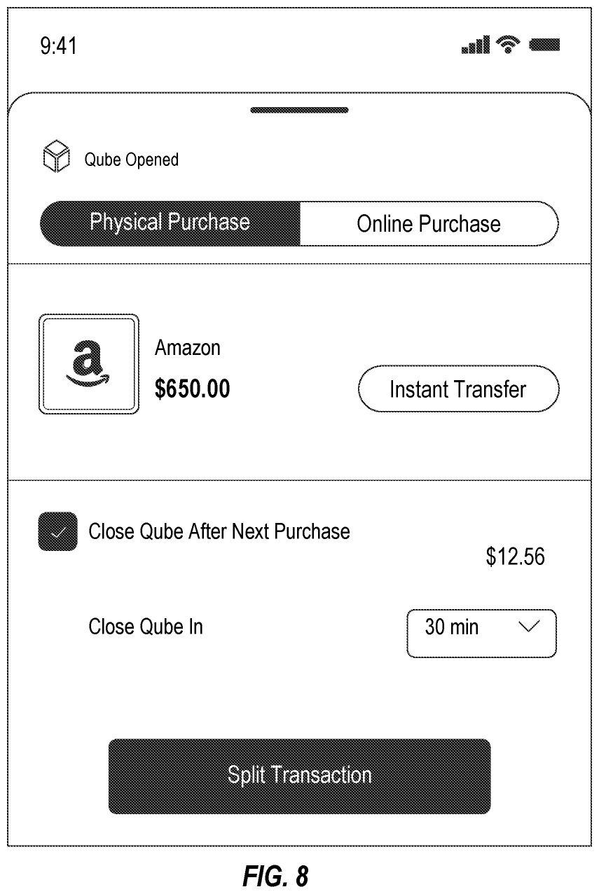

FIG. 8 depicts another user interface screenshot of a system for implementing a transaction split according to some embodiments and implementations. The user interface depicted in FIG. 8 allows a user to set up the transaction before it takes place. For example, this may allow a user to invite another user to the transaction but also place controls of how the transaction is to occur, thereby affecting the scope of the permission from the invited user. As indicated in this image, in addition to the split options previously mentioned, some embodiments may allow a user to close the “qube” or account from which transaction costs are to be split, either after a predetermined time period or after the next purchase has been made using the card. Thus, for example, a user may decide that authorization for a purchase using the user's card may only take place for the next 30 minutes (anticipating that the split transaction will take place during this time period), or the user may decide that the card/account is to be open for an indefinite period of time but to automatically close after the contemplated transaction has taken place.

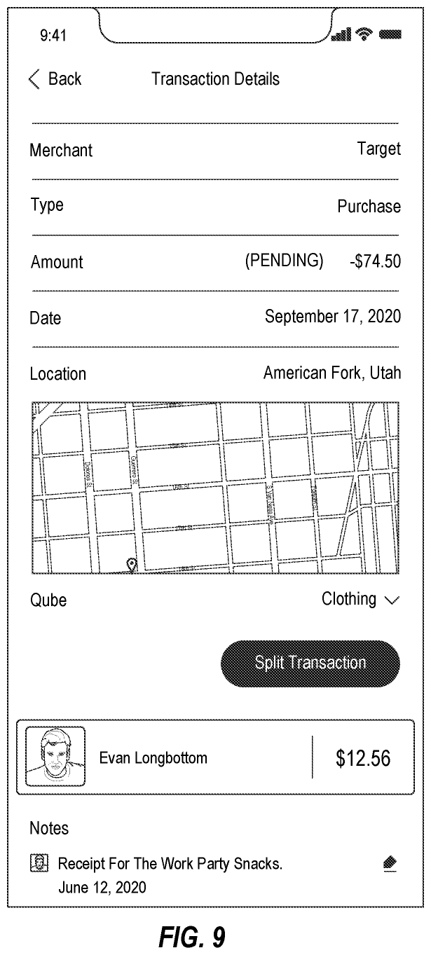

Another example of a user interface screenshot is shown in FIG. 9. The screenshot of FIG. 9 is intended to be used primarily, if not exclusively, to attempt to split transaction costs after a transaction has taken place. As shown in this image, a user may be able to browse previous transactions by, for example, merchant, type of transaction, amount, date, location, spending category (Qube), or the like. Once the previous transaction has been identified, the user may, as previously mentioned, identify one or more other users to attempt to split the transaction costs, identify an amount or percentage for the split (if not even), and request a split. The app may also allow users to keep notes about the transaction. In some cases, the notes may be configured to automatically populate a receipt for each split transaction to allow users to reference previous transactions and splits.

As used herein, a software module or component may include any type of computer instruction or computer executable code located within a memory device and/or m-readable storage medium. A software module may, for instance, comprise one or more physical or logical blocks of computer instructions, which may be organized as a routine, program, object, component, data structure, etc., that perform one or more tasks or implements particular abstract data types.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

Furthermore, embodiments and implementations of the inventions disclosed herein may include various steps, which may be embodied in machine-executable instructions to be executed by a general-purpose or special-purpose computer (or another electronic device). Alternatively, the steps may be performed by hardware components that include specific logic for performing the steps, or by a combination of hardware, software, and/or firmware.

Embodiments and/or implementations may also be provided as a computer program product including a machine-readable storage medium having stored instructions thereon that may be used to program a computer (or other electronic device) to perform processes described herein. The machine-readable storage medium may include, but is not limited to: hard drives, floppy diskettes, optical disks, CD-ROMs, DVD-ROMs, ROMs, RAMs, EPROMs, EEPROMs, magnetic or optical cards, solid-state memory devices, or other types of medium/machine-readable medium suitable for storing electronic instructions. Memory and/or datastores may also be provided, which may comprise, in some cases, non-transitory machine-readable storage media containing executable program instructions configured for execution by a processor, controller/control unit, or the like, of a computer or other computing device, such as a mobile smartphone.

The foregoing specification has been described with reference to various embodiments and implementations. However, one of ordinary skill in the art will appreciate that various modifications and changes can be made without departing from the scope of the present disclosure. For example, various operational steps, as well as components for carrying out operational steps, may be implemented in various ways depending upon the particular application or in consideration of any number of cost functions associated with the operation of the system. Accordingly, any one or more of the steps may be deleted, modified, or combined with other steps. Further, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced, are not to be construed as a critical, a required, or an essential feature or element.

Those having skill in the art will appreciate that many changes may be made to the details of the above-described embodiments without departing from the underlying principles of the invention. The scope of the present inventions should, therefore, be determined only by the following claims.

1. A method for collaborative money management between a plurality of users of a money management system, the method comprising the steps of:
receiving a transaction split request from a first user of a collaborative money management system, wherein the transaction split request is entered on a mobile application or a web-based application under control of the first user;
sending a transaction split request notification to a second user of the collaborative money management system, wherein the transaction split request comprises:
a total cost of a transaction; and
a proposed split of the total cost of the transaction;
receiving a notification from the second user responsive to the transaction split request; and
upon determining that the second user has approved the transaction split request, automatically transferring funds between accounts of the first user and the second user in the collaborative money management system to accomplish the approved transaction split request.

2. The method of claim 1, further comprising facilitating completion of the transaction.

3. The method of claim 2, wherein the step of facilitating completion of the transaction takes place before the step of sending the transaction split request notification.

4. The method of claim 2, wherein the step of facilitating completion of the transaction comprises receiving a transaction notification associated with a payment means, wherein the payment means is linked with a virtual account, and wherein the virtual account is linked with a financial institution account.

5. The method of claim 4, wherein the payment means comprises a debit card linked with the virtual account.

6. The method of claim 1, wherein the step of automatically transferring funds between accounts of the first user and the second user takes place automatically at the time of completion of the transaction.

7. The method of claim 1, wherein the transaction split involves more than two users of the collaborative money management system.

8. The method of claim 7, wherein the step of automatically transferring funds between accounts comprises automatically transferring funds between accounts of each of the users involved in the transaction split to accomplish the approved transaction split request.

9. The method of claim 1, further comprising:
receiving incoming transaction data; and
automatically calculating split amounts based upon the approved transaction split request using the incoming transaction data.

10. A method for collaborative money management between a plurality of users of a money management system, the method comprising the steps of:
receiving a request to share an account from a first user of a collaborative money management system;
receiving a response to the request to share from a second user of the collaborative money management system;
responsive to an acceptance of the request to share by the second user of the collaborative money management system, establishing a joint account under which the first user and the second user may fund and/or spend from the joint account;
establishing a set of rules under which each of the users of the joint account may fund and/or spend from the joint account;
receiving a request to authorize a transaction;
evaluating the set of rules to determine whether the transaction is authorized; and
upon determining that the request to authorize the transaction meets each rule in the set of rules:
authorizing the transaction; and
automatically transferring funds between virtual accounts of at least the first user and the second user in accordance with the set of rules.

11. The method of claim 10, wherein the joint account comprises a primary account holder and one or more secondary account holders, and wherein the step of establishing a set of rules is performed using rules set by the primary account holder.

12. The method of claim 10, wherein the joint account comprises a virtual account linked with a financial institution account.

13. The method of claim 12, wherein the step of authorizing the transaction comprises transferring of funds to the joint account from the financial institution account.

14. The method of claim 13, wherein the step of transferring of funds to the joint account from the financial institution account takes place at the time of the transaction.

15. The method of claim 10, wherein the joint account comprises a company joint account, and wherein each of the users of the joint account are employees of the company.

16. The method of claim 15, wherein the joint account comprises a virtual account associated with a particular company project.

17. A system for collaborative money management, comprising:
one or more processors;
a computer readable memory operably coupled with the one or more processors;
a transaction authorization module configured to receive a transaction split request from a first user of the collaborative money management system from a mobile application or a web-based application under control of the first user, wherein the transaction authorization module is configured to send a transaction split request notification to a second user of the collaborative money management system and approve or deny the transaction split request, wherein the transaction split request comprises:
a total cost of a transaction; and
a proposed split of the total cost of the transaction; and
a transaction splitting module configured to, upon approval of the transaction split request, automatically transfer funds between accounts of the first user and the second user in the collaborative money management system to accomplish the approved transaction split request.

18. The system of claim 17, wherein the system is configured to allow users to split transaction costs either before or after the transaction has taken place.

19. The system of claim 17, wherein the system is configured to allow users to pre-approve a transaction split, and wherein the transaction splitting module is configured to automatically transfer funds between users of the collaborative money management system according to an approved transaction split at the time of the transaction.

20. The system of claim 17, wherein the transaction splitting module is configured to automatically refund funds between accounts of the first user and the second user upon notification of a cancellation or refund of a transaction of an approved transaction split request.
